(19) United States
(12) Patent Application Publication
(10) Pub. No.: US 2024/0154875 A1
(43) Pub. Date: May 9, 2024

(54) NETWORK SYSTEM CONSTRUCTION DEVICE, COMMUNICATION SYSTEM, NETWORK SYSTEM CONSTRUCTION METHOD, AND NON-TRANSITORY COMPUTER-READABLE MEDIUM

(71) Applicant: NEC Corporation, Minato-ku, Tokyo (JP)

(72) Inventor: Ryota KUBONIWA, Tokyo (JP)

(73) Assignee: NEC Corporation, Minato-ku, Tokyo (JP)

(21) Appl. No.: 18/281,400

(22) PCT Filed: Mar. 14, 2022
(86) PCT No.: PCT/JP2022/011286

§ 371 Date: Sep. 11, 2023

(30) Foreign Application Priority Data
Mar. 19, 2021 (JP) 2021-045743

(51) Int. Cl. H04L 41/0895; H04L 41/0806; H04L 41/0853

(52) U.S. Cl. CPC H04L 41/0895; H04L 41/0806; H04L 41/0853

(57) ABSTRACT

An object of the present invention is to provide a network system construction device that can increase the efficiency of system construction. A network system construction device (10) according to the present disclosure includes: an acquisition unit (11) that acquires identification information for identifying a network system that is provided from a cloud provider and in which a combination of a plurality of system elements is patterned; and a setting unit (12) that sets configuration information associated with the identification information to the network system identified by the identification information.

### TECHNICAL FIELD

The present disclosure relates to a network system construction device, a communication system, a network system construction method, and a program.

### BACKGROUND ART

In recent years, there has been an increase in the number of business operators that construct a system by utilizing network resources provided by a cloud provider. A business operator who performs system construction constructs a system for providing an application or a service by utilizing the provided network resources. A business operator who performs system construction constructs a system by repeatedly performing environment construction for operating an application, application release, application test, and the like.

Patent Literature 1 discloses creating a template in which processing patterns are standardized in order to efficiently construct a system. Patent Literature 1 discloses that creating a template in which processing patterns are standardized increases the efficiency of designing and manufacturing operations for system construction are made efficient, and reduces man-hours.

### CITATION LIST

### Patent Literature

Patent Literature 1: Japanese Unexamined Patent Application Publication No. 2000-222197

### SUMMARY OF INVENTION

### Technical Problem

In the case of constructing a system by utilizing network resources provided by a cloud provider, a designer, an operator, a developer, or the like who constructs the system needs to consider a combination of a large number of pieces of software and hardware to be handled in the system. When a system is constructed in such an environment, there is a problem that it is difficult to automate a system construction procedure because a large number of pieces of software and hardware may be affected.

An object of the present disclosure is to provide a network system construction device, a communication system, a network system construction method, and a program that can increase the efficiency of system construction.

### Solution to Problem

A network system construction device according to a first aspect of the present disclosure includes: an acquisition unit that acquires identification information for identifying a network system that is provided from a cloud provider and in which a combination of a plurality of system elements is patterned; and a setting unit that sets configuration information associated with the identification information to the network system identified by the identification information.

A communication system according to a second aspect of the present disclosure includes: a network system construction device including an acquisition unit that acquires identification information for identifying a network system that is provided from a cloud provider and in which a combination of a plurality of system elements is patterned, and a setting unit that sets configuration information associated with the identification information to the network system identified by the identification information; and a database that manages the identification information and the configuration information in association with each other.

A network system construction method according to a third aspect of the present disclosure includes: acquiring identification information for identifying a network system that is provided from a cloud provider and in which a combination of a plurality of system elements is patterned; and setting configuration information associated with the identification information to the network system identified by the identification information.

A program according to a fourth aspect of the present disclosure causes a computer to execute: acquiring identification information for identifying a network system that is provided from a cloud provider and in which a combination of a plurality of system elements is patterned; and setting configuration information associated with the identification information to the network system identified by the identification information.

### Advantageous Effects of Invention

According to the present disclosure, it is possible to provide a network system construction device, a communication system, a network system construction method, and a program that can increase the efficiency of system construction.

### BRIEF DESCRIPTION OF DRAWINGS

FIG. 1 is a configuration diagram of a network system construction device according to a first example embodiment.

FIG. 2 is a configuration diagram of a communication system according to a second example embodiment.

FIG. 3 is a configuration diagram of a network system construction device according to a second example embodiment.

FIG. 4 is a diagram illustrating a pattern management database according to the second example embodiment.

FIG. 5 is a diagram illustrating a configuration information database according to the second example embodiment.

FIG. 6 is a flowchart of a process of applying configuration information to a network system according to the second example embodiment.

FIG. 7 is a flowchart of a confirmation process after release according to the second example embodiment.

FIG. 8 is a diagram for describing update contents of the configuration information database according to the second example embodiment.

FIG. 9 is a diagram for describing update contents of the configuration information database according to the second example embodiment.

FIG. 10 is a configuration diagram of a network system construction device according to each example embodiment.

### EXAMPLE EMBODIMENTS

### First Example Embodiment

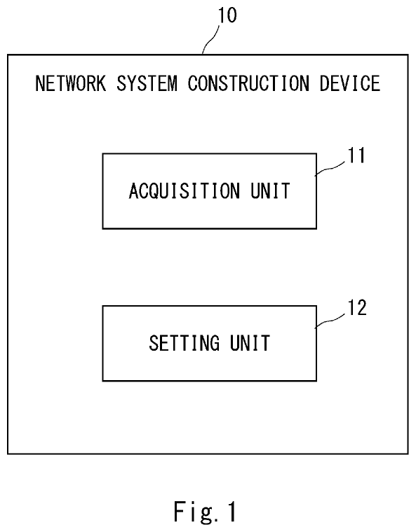

Hereinafter, example embodiments of the present invention will be described with reference to the drawings. A configuration example of a network system construction device 10 according to a first example embodiment will be described with reference to FIG. 1. The network system construction device 10 may be a computer device that operates when a processor executes a program stored in a memory. The network system construction device 10 may be a server device, for example.

The network system construction device 10 includes an acquisition unit 11 and a setting unit 12. The acquisition unit 11 and the setting unit 12 may be software components or modules whose processing is carried out by causing the processor to execute the program stored in the memory. Alternatively, the acquisition unit 11 and the setting unit 12 may be hardware components such as circuits or chips.

The acquisition unit 11 acquires identification information for identifying a network system. The network system is provided by a cloud provider and includes a plurality of patterned system elements.

The cloud provider has a cloud infrastructure as a network or a system for implementing cloud computing to be provided. The cloud infrastructure may be a combination of a plurality of hardware elements, a combination of plurality of software elements, or a combination of hardware elements and software elements.

The network system is a cloud infrastructure provided by a cloud provider, for example, and may be referred to as a cloud area available to the user. Alternatively, the cloud infrastructure may be referred to as a resource or a cloud resource available to the user. The network system is a service providing system that provides a plurality of services via a network, a business system in a company, or the like, for example. A business operator or the like who is a user of the cloud infrastructure is provided with resources from the cloud provider, and implements various services by utilizing the provided resources.

The identification information may be information that uniquely identifies a network system, for example. Uniquely identifying a network system also includes identifying a combination of plurality of system elements that constitutes the network system. That is, the identification information may be information for identifying a pattern of a combination of a plurality of system elements included in the network system.

The system elements are elements constituting a network system. The system elements include a server, a network device, a storage device, a service function, and the like, for example. The server may be a physical server device or a virtual server on which an operating system (OS) and middleware operate. The network device and the storage device may also be physical devices or virtual devices. The service function refers to a function provided by middleware, an application program, or the like, and may be simply referred to as “function” hereinafter.

The virtual server or the virtual device may be a function, software, or process that operates on virtual software installed in a physical device. The virtual software may virtualize hardware resources to cause a plurality of virtual servers or virtual devices to share the hardware resources. The plurality of virtual servers or virtual devices may operate on a common virtual OS or may operate on different virtual OSs. Alternatively, a plurality of virtual servers or virtual devices may operate on an OS mounted on a physical device and may not use a virtual OS.

Patterning combinations of a plurality of system elements may be predetermining combinations of a plurality of system elements. Further, patterning combinations of a plurality of system elements may be limiting or reducing the types of system elements that constitute a network system. Limiting the types of system elements constituting a network system may be limiting the types of server devices used in advance if a large number of types of server devices can be used as server devices that are system elements, for example.

Patterning combinations of a plurality of system elements makes it possible to reduce the combinations of a plurality of system elements that constitutes a network system.

The setting unit 12 sets the configuration information associated with the identification information to the network system identified by the identification information. The configuration information includes parameter information and a program set to system elements constituting the network system. The parameter information may be referred to as configuration information, a configuration file, or the like, for example. Setting the configuration information to the network system enables provision of services via the network system.

As described above, the network system construction device 10 in FIG. 1 patterns a combination of a plurality of system elements constituting the network system. Accordingly, the operator of the network system can limit the number of system elements to be considered in network construction, it is easy to automate the construction of the network system as compared with a case where the number of system elements is not limited. That is, associating the identification information of the network system with the configuration information enables automated setting of the configuration information to the network system. As a result, using the network system construction device 10 reduces the time required for constructing the network system.

### Second Example Embodiment

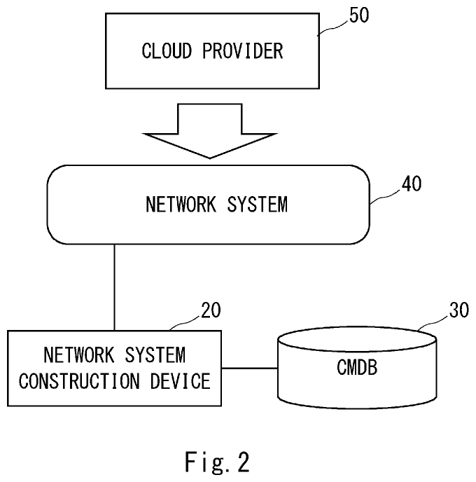

Next, a configuration example of a communication system according to a second example embodiment will be described with reference to FIG. 2. The communication system in FIG. 2 includes a network system construction device 20, a configuration management database (CMDB) 30, and a network system 40. The network system 40 is a cloud infrastructure provided by a cloud provider 50. The network system construction device 20 sets configuration information for providing a service to the network system 40.

The network system 40 is constructed by combining a plurality of system elements. The combination of the plurality of system elements may be a combination of physical devices or a combination of virtual devices operating as software. Alternatively, the combination of the plurality of system elements may be a combination of a physical device and a virtual device.

Next, the CMDB 30 will be described. The CMDB 30 is a database that holds configuration information set to the network system 40. The term storing may be replaced with memorizing, recording, registering, or the like. For example, a developer who has designed configuration information based on a design document, a required specification document, or the like registers the configuration information in the CMDB 30. Alternatively, the developer may update the configuration information registered in the CMDB 30. The operator who applies the configuration information to the network system 40 applies the configuration information registered or stored in the CMDB 30 to the network system 40. The developer or the operator may register the configuration information in the CMDB 30 or extract the configuration information from the CMDB 30 via a network using a computer device.

When applying the configuration information to the network system 40, the operator executes procedures of pre-configuration, release, and testing of the network system 40. The pre-configuration is a procedure for operating the network system 40, and may be a procedure for setting parameter information for operating system elements, for example. The parameter information is included in the configuration information. The parameter information may be a value related to a timer operating in each system element, a size of data transmitted or processed by each system element, or the like, for example. The parameter information is a value referred to by a program and may be called configuration information.

The release may be registering, configuring, or installing a program applied to a system element in the system element. Alternatively, the release may be updating the program of the already set system element. The program is included in the configuration information.

The test is to check whether the released program is normally operating on the network system 40. For example, the operator may perform a predetermined test to determine the normality of the network system 40. Alternatively, the test may be automatically performed by a computer without intervention of an operator or the like.

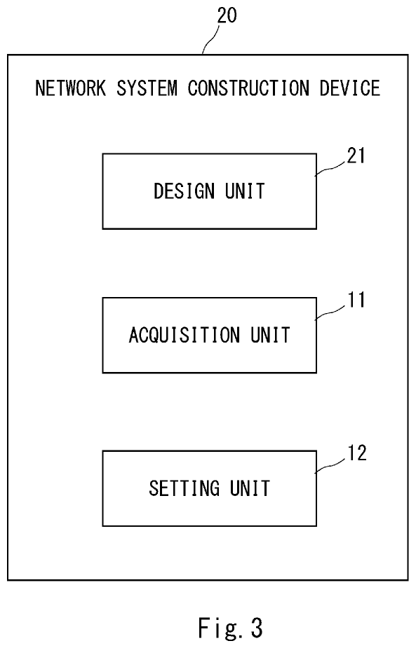

Next, a configuration example of the network system construction device according to the second example embodiment will be described with reference to FIG. 3. The network system construction device 20 has a configuration in which a design unit 21 is added to the network system construction device 10 in FIG. 1. The design unit 21 may be a software component or module whose processing is carried out by causing the processor to execute the program stored in the memory. Alternatively, the design unit 21 may be a hardware component such as a circuit or a chip. Since an acquisition unit 11 and a setting unit 12 are similar to those of the network system construction device 10 in FIG. 1, differences from the network system construction device 10 in FIG. 1 will be mainly described below.

The design unit 21 patterns a combination of a plurality of system elements. That is, the design unit 21 generates a combination of system elements. For example, the design unit 21 may pattern a combination of a plurality of system elements according to a predetermined criterion. The predetermined criterion may be information input by the developer.

For example, the predetermined criterion may be a criterion that a network device used as a system element is two types of switches. In this case, a switch A and a switch B may be selected as system elements, for example. The switch A and the switch B may be switches having different functions.

Alternatively, the predetermined criterion may be a criterion that a server used as a system element is two types of servers having predetermined processing capabilities. In this case, a server of a processing capability A equal to or higher than a predetermined processing capability and a server of a processing capability B equal to or higher than a predetermined processing capability may be selected, for example. The processing capability may be a processing capability of a processor, a memory size, a data transfer speed, or the like, for example.

As the predetermined criterion, limiting the types of devices to be used to N types (N is an integer of 1 or more) makes it possible to use a specific limited number of devices among a large number of devices. In addition, the predetermined criterion for using a specific limited number of devices among a large number of devices is not limited to the above criterion.

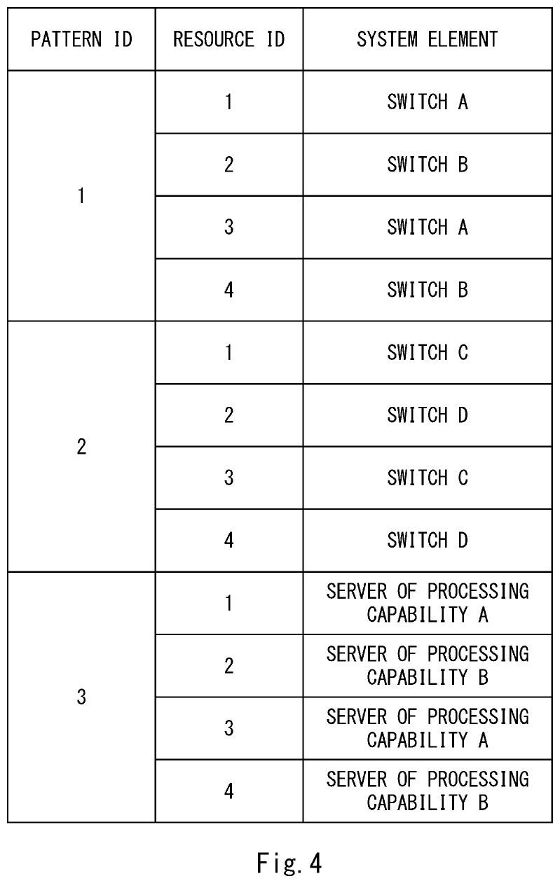

The design unit 21 may store the generated combination of system elements in a CMDB 30 as a pattern management database illustrated in FIG. 4. The pattern management database has pattern IDs, resource IDs, and system elements in associated with one another. The pattern ID is identification information indicating a combination of system elements. The resource ID is identification information indicating a resource provided by the cloud provider. For example, when a resource of a network system provided by a cloud provider is divided into a plurality of resources, a resource ID may be used as information for identifying each divided resource. The system element indicates a system element used in a resource defined with the resource ID. In the example of the pattern management database in FIG. 4, three combinations of system elements are managed.

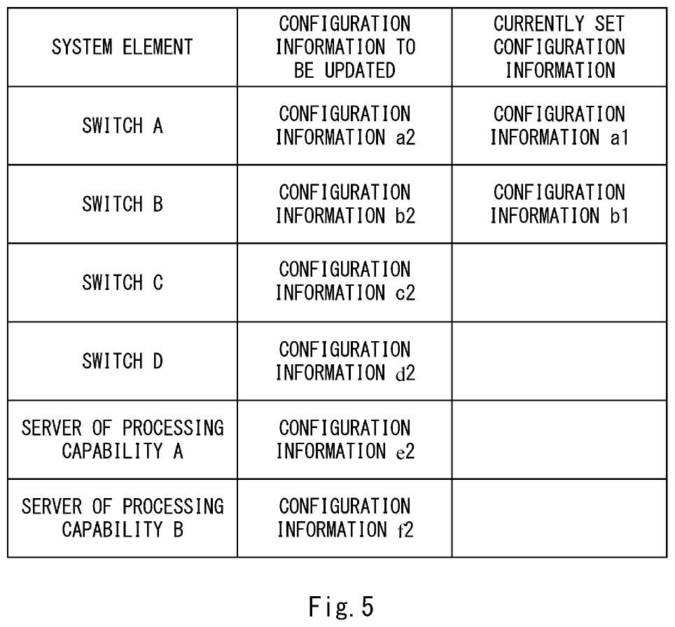

The CMDB 30 further holds a configuration information database illustrated in FIG. 5. The configuration information database manages system elements and configuration information in association with each other. The configuration information database manages configuration information with a history. For example, as illustrated in FIG. 5, the configuration information database may manage configuration information that is currently set and configuration information that is scheduled to be updated. The currently set configuration information is configuration information already set to the network system 40. That is, the currently set configuration information may be configuration information already operated in the network system 40.

For example, it is assumed that the network system 40 is currently constructed by a combination of the switch A and the switch B as system elements. It is also assumed that configuration information a1 is applied to the switch A, and configuration information b1 is applied to the switch B.

When the developer designs configuration information to be newly applied to the network system 40 in the future, the designed configuration information is registered in the configuration information database of the CMDB 30. The configuration information designed by the developer is managed in the configuration information to be updated. The developer designs different configuration information for each system element. For example, the developer designs configuration information a2 as the configuration information of the switch A, and designs configuration information b2 as the configuration information of the switch B. It is assumed that the developer also designs configuration information of a switch C, a switch D, a server of processing capability A, and a server of processing capability B. As described above, the configuration information database managed in the CMDB 30 has the latest configuration information applied to the network system 40 and the configuration information to be updated. The configuration information database may have not only the latest configuration information applied to the network system 40 but also configuration information applied in the past.

Returning to FIG. 3, the acquisition unit 11 acquires a pattern ID input from a user interface operated by the operator or input via a network from a computer device operated by the operator, for example. The operator inputs a pattern ID when applying new configuration information to the network system 40. The acquisition unit 11 outputs the pattern ID to the setting unit 12.

Upon acquiring the pattern ID, the setting unit 12 specifies a combination of system elements used for each resource identified by the resource ID, using the pattern management database. For example, upon acquiring a pattern ID_1, the setting unit 12 specifies the switch A and the switch B as a combination of system elements. Further, the setting unit 12 acquires or extracts the configuration information a2 of the switch A and the configuration information b2 of the switch B using the configuration information database.

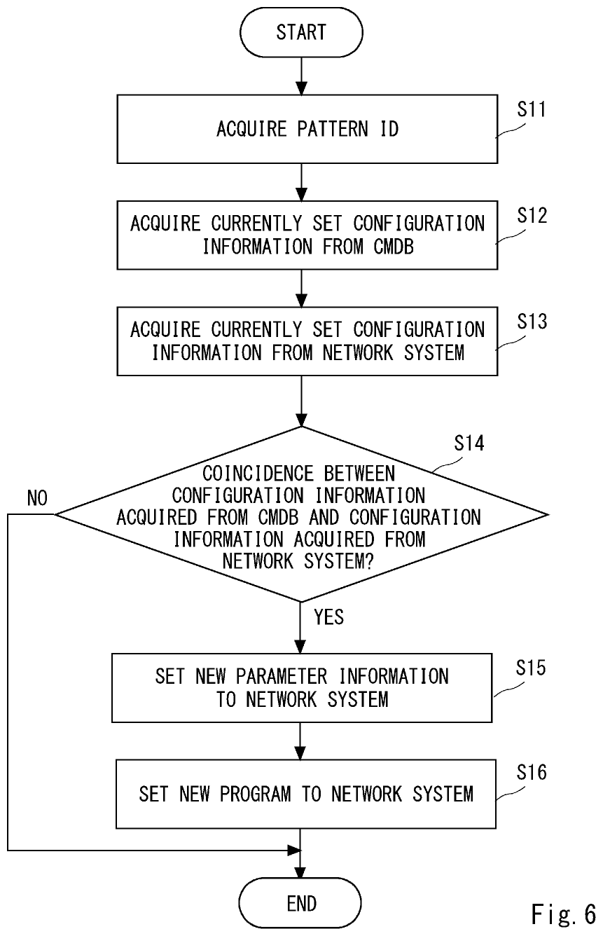

The setting unit 12 applies the configuration information a2 and the configuration information b2 to the network system 40. A flow of process of applying the configuration information to the network system 40 will be described with reference to FIG. 6.

First, the setting unit 12 acquires the pattern ID from the acquisition unit 11 (S11). Next, the setting unit 12 acquires the configuration information set to the current network system 40 from the configuration information database stored in the CMDB 30 (S12).

Next, the setting unit 12 acquires currently set configuration information from the network system 40 (S13). For example, the network system construction device 20 may have a tool, a program, or the like that acquires configuration information from the network system 40. For example, the tool or the program may convert instruction information output from the setting unit 12 into a command to be issued to the network system 40. In this case, the setting unit 12 instructs a tool or the like to acquire the configuration information to acquire the configuration information from the network system 40.

Next, the setting unit 12 compares the configuration information acquired from the CMDB 30 with the configuration information acquired from the network system 40, and determines whether they coincide with each other (S14). When determining that the configuration information acquired from the CMDB 30 does not coincide with the configuration information acquired from the network system 40, the setting unit 12 ends the process. Generally, the developer designs new configuration information based on the currently set configuration information as a prerequisite. Therefore, when the configuration information acquired from the CMDB 30 does not coincide with the configuration information acquired from the network system 40, the new configuration information may not operate normally. Therefore, when the configuration information acquired from the CMDB 30 does not coincide with the configuration information acquired from the network system 40, the configuration information setting process is canceled.

When determining that the configuration information acquired from the CMDB 30 coincide with the configuration information acquired from the network system 40, the setting unit 12 sets new parameter information to be updated to the network system 40 (S15). For example, the network system construction device may have a tool, a program, or the like that sets the configuration information to the network system 40. In this case, the setting unit 12 may instruct the tool or the like to set the parameter information. Step S15 corresponds to a pre-configuration of the network system 40.

The setting unit 12 specifies the system element associated with the pattern ID acquired in step S11 using the pattern management database, and further specifies the configuration information to be updated using the configuration information database. The setting unit 12 may specify the configuration information to be updated after step S11 or after step S14.

In step S15, the setting unit 12 may set all pieces of parameter information included in the configuration information to be updated to the network system 40, or may set some pieces of parameter information to the network system 40. Alternatively, the setting unit 12 may also set, to the network system 40, some of programs included in the configuration information to be updated together with the parameter information.

Next, the setting unit 12 sets a program included in the configuration information to be updated in the network system 40 (S16). If some of the programs included in the configuration information have already been set in step S15, the setting unit 12 sets the remaining programs to the network system 40. Step S16 corresponds to release to the network system 40.

After setting the parameter information in the network system 40 in step S15, the setting unit 12 may check the setting status in the network system 40. For example, after setting the parameter information to the network system 40 in step S15, the setting unit 12 may acquire the setting information in the network system 40. The setting unit 12 may acquire the setting information using a tool for acquiring the configuration information from the network system 40.

The setting unit 12 may compare the parameter information set in step S15 with the setting information acquired from the network system 40, and execute step S16 when the parameter information coincides with the setting information.

The setting unit 12 may autonomously execute step S16 after executing the processing of step S15, or may execute a setting status confirmation process in the network system 40 between step S15 and step S16. The setting unit 12 autonomously executes the setting status confirmation process in the network system 40 and the process in step S16. The setting unit 12 autonomously executing step S16 and the like means executing the processes without waiting for input of instruction information by the operator or the like. The autonomous execution may also be said to be automatic execution.

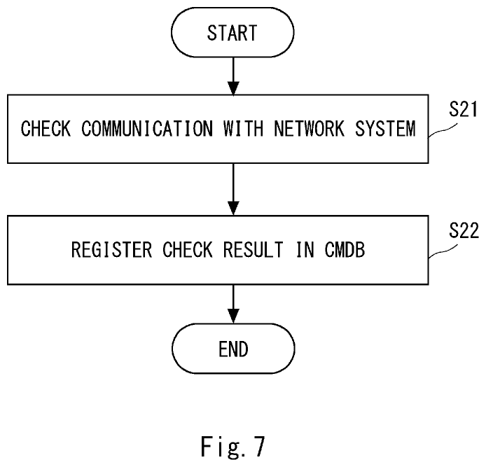

Next, a flow of a post-release checking process will be described with reference to FIG. 7. The post-release checking process may be performed as part of a post-release test, or may be performed as a process or procedure different from the post-release test. The checking process may also be said to be monitoring processing.

First, the setting unit 12 checks communication with the network system (S21). For example, the setting unit 12 may autonomously check communication with the network system 40 after the release of the program, or may check communication with the network system 40 when instruction information of the checking process is input by the operator.

The communication check may be a check as to whether the setting unit 12 can log in to the system elements constituting the network system 40, for example. The communication check may further include, after successfully logging in to a system element, checking the reachability of data to another system element by the setting unit 12. The data reachability may be checked by the setting unit 12 transmitting a message from a system element to which the setting unit 12 has logged in to another system element and then determining whether the setting unit 12 receives a response message from the other system element, for example.

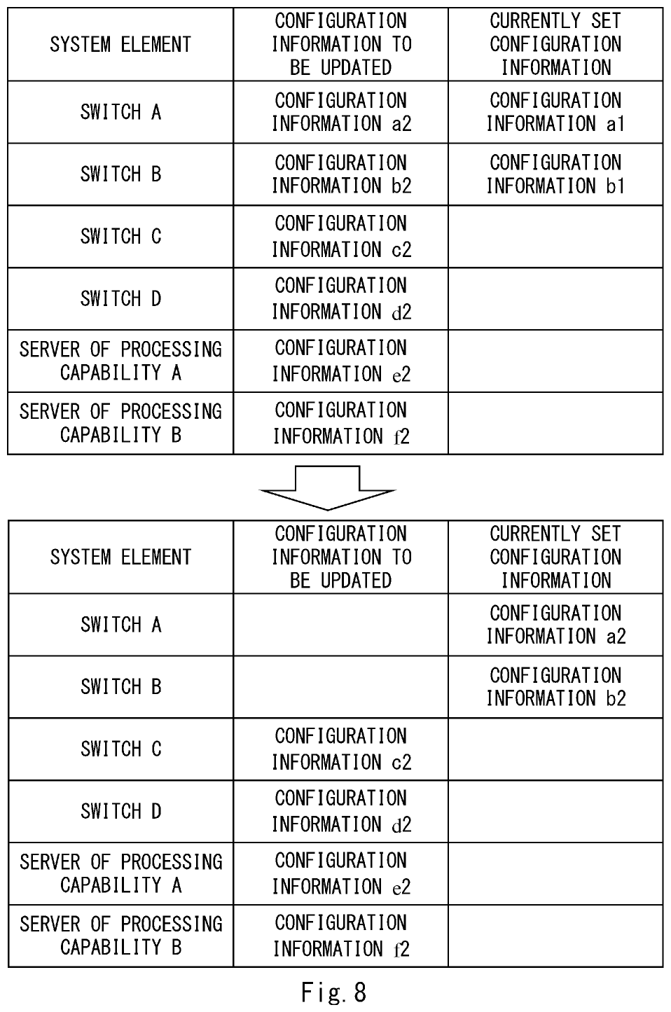

Next, the setting unit 12 registers a check result in the CMDB 30 (S22). The check result may also be said to be a monitoring result. For example, when the communication check result is normal, the setting unit 12 may change the configuration information currently set in the configuration information database to new updated configuration information. For example, as illustrated in FIG. 8, when the configuration information of the switch A and the switch B is released and the communication check result is normal, the currently set configuration information may be updated to the new configuration information, and the configuration information to be updated may be left blank.

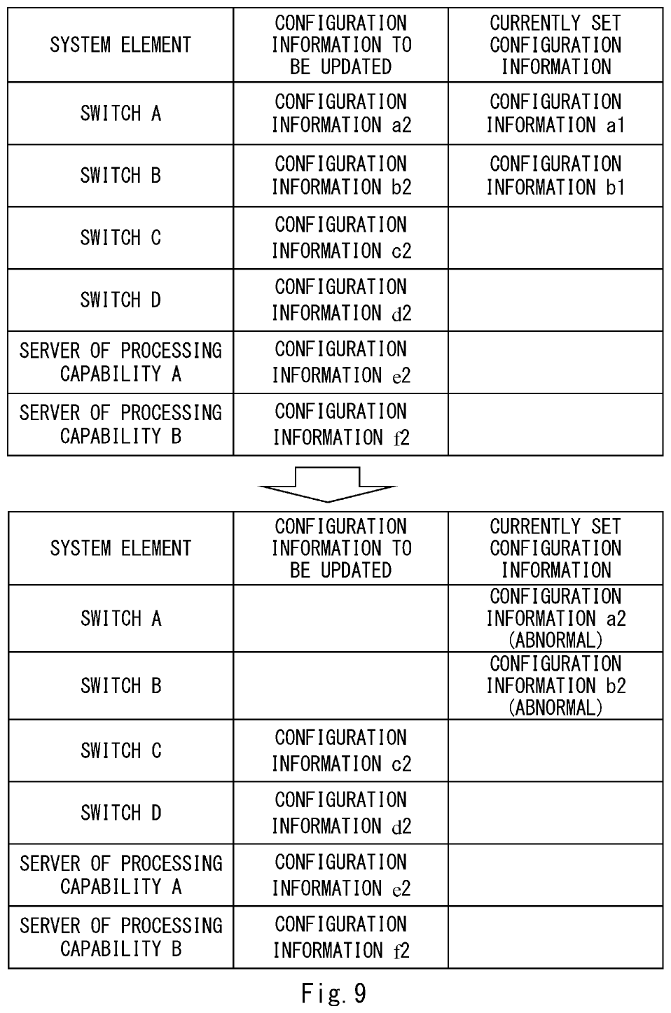

When the communication check result is abnormal, the setting unit 12 may set information indicating that the updated configuration information is abnormal in the currently set configuration information, to the configuration information database as illustrated in FIG. 9, for example. When the communication check result is normal, the setting unit 12 may set information indicating that the updated configuration information is normal in the currently set configuration information.

The operator can check the post-release communication check result by checking the configuration information database. When the post-release communication check result is normal, the operator can execute the post-release test. When the post-release communication check result is abnormal, the operator can consider switching back the configuration information, designing new configuration information, or the like.

As described above, when acquiring the pattern ID related to the network system 40, the network system construction device 20 according to the second example embodiment can autonomously set new configuration information to the network system 40. In the cloud infrastructure, a combination of a large number of system elements can be considered by using a virtualization technology or the like, for example. Therefore, it is possible to automate pre-configuration and release of configuration information by patterning combinations of system elements and limiting the number of combinations of system elements.

In setting the configuration information, the network system construction device 20 can smoothly perform the pre-configuration and the release by executing in advance a process of comparison of the configuration information for checking the current state.

The network system construction device 20 can determine whether the configuration information has been normally set at an early stage by performing the post-release communication check.

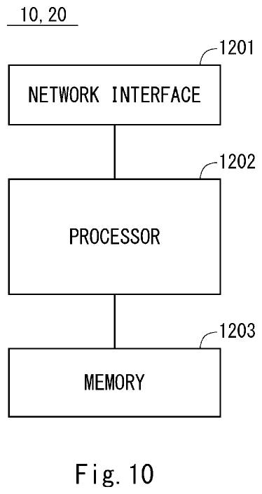

FIG. 10 is a block diagram illustrating a configuration example of the network system construction device 10 and the network system construction device 20 (hereinafter, called the network system construction device 10 and the like). Referring to FIG. 10, the network system construction device 10 and the like include a network interface 1201, a processor 1202, and a memory 1203. The network interface 1201 may be used to communicate with other network nodes. The network interface 1201 may include, for example, a network interface card (NIC) conforming to IEEE 802.3 series.

The processor 1202 reads and executes software (computer program) from the memory 1203 to perform processing in the network system construction device and the like described with reference to the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 through an input/output (I/O) interface (not shown).

In the example of FIG. 10, the memory 1203 is used to store a software module group. The processor 1202 can perform the processing in the network system construction device 10 and the like described in the above-described example embodiments by reading and executing these software module groups from the memory 1203.

As described with reference to FIG. 10, each of the processors included in the network system construction device 10 and the like in the above-described example embodiments executes one or more programs including a command group for causing a computer to perform the algorithm described with reference to the drawings.

In the above-described example, the program can be stored using various types of non-transitory computer-readable media to be supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM). The program may be supplied to the computer by various types of transitory computer-readable media. Examples of the transitory computer-readable media include electrical signals, optical signals, and electromagnetic waves. The transitory computer-readable medium can provide the program to the computer via a wired communication line such as an electric wire and optical fibers or a wireless communication line.

Note that the present disclosure is not limited to the above-described example embodiments, and can be appropriately modified without departing from the gist.

Some or all of the above-described example embodiments may be described as in the following Supplementary Notes, but are not limited to the following Supplementary Notes.

### SUPPLEMENTARY NOTE 1

A network system construction device including:
an acquisition unit that acquires identification information for identifying a network system that is provided from a cloud provider and in which a combination of a plurality of system elements is patterned; and
a setting unit that sets configuration information associated with the identification information to the network system identified by the identification information.

### SUPPLEMENTARY NOTE 2

The network system construction device according to Supplementary Note 1, further including a system design unit that patterns a combination of the plurality of system elements.

### SUPPLEMENTARY NOTE 3

The network system construction device according to Supplementary Note 2, wherein the system design unit generates the plurality of system elements of which combination is patterned by using the network system in which a hardware resource is virtualized.

### SUPPLEMENTARY NOTE 4

The network system construction device according to Supplementary Note 2 or 3, wherein the system design unit generates a plurality of virtual devices having a common function, and designs the network system by using the plurality of virtual devices.

### SUPPLEMENTARY NOTE 5

The network system construction device according to Supplementary Note 2 or 3, wherein the system design unit generates a plurality of virtual devices having a common processing capability, and constructs the network system by using the plurality of virtual devices.

### SUPPLEMENTARY NOTE 6

The network system construction device according to any one of Supplementary Notes 1 to 4, wherein the configuration information includes parameter information for operating the system elements and a program applied to the system elements.

### SUPPLEMENTARY NOTE 7

The network system construction device according to Supplementary Note 6, wherein the setting unit sets the parameter information associated with the identification information to the system elements, and then autonomously applies the program to the system elements.

### SUPPLEMENTARY NOTE 8

The network system construction device according to any one of Supplementary Notes 1 to 7, further including a database that manages the configuration information set to the network system,
wherein the setting unit collects current setting information of the network system from the network system, compares the configuration information managed in the database with the current setting information of the network system, and sets the configuration information associated with the identification information to the network system when the configuration information managed in the database coincides with the current setting information of the network system.

### SUPPLEMENTARY NOTE 9

The network system construction device according to Supplementary Note 8, wherein the setting unit monitors the network system to which the configuration information associated with the identification information is set, and registers a monitoring result in the database.

### SUPPLEMENTARY NOTE 10

A communication system including:
a network system construction device including an acquisition unit that acquires identification information for identifying a network system that is provided from a cloud provider and in which a combination of a plurality of system elements is patterned, and a setting unit that sets configuration information associated with the identification information to the network system identified by the identification information; and
a database that manages the identification information and the configuration information in association with each other.

### SUPPLEMENTARY NOTE 11

The communication system according to Supplementary Note 10, wherein the network system construction device further includes a system design unit that patterns a combination of the plurality of system elements.

### SUPPLEMENTARY NOTE 12

A network system construction method including:
acquiring identification information for identifying a network system that is provided from a cloud provider and in which a combination of a plurality of system elements is patterned; and
setting configuration information associated with the identification information to the network system identified by the identification information.

### SUPPLEMENTARY NOTE 13

A program for causing a computer to execute:
acquiring identification information for identifying a network system that is provided from a cloud provider and in which a combination of a plurality of system elements is patterned; and
setting configuration information associated with the identification information to the network system identified by the identification information.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2021-045743 filed on Mar. 19, 2021, the entire disclosure of which is incorporated herein.

### REFERENCE SIGNS LIST

10 NETWORK SYSTEM CONSTRUCTION DEVICE
11 ACQUISITION UNIT
12 SETTING UNIT
20 NETWORK SYSTEM CONSTRUCTION DEVICE
21 DESIGN UNIT
30 CMDB
40 NETWORK SYSTEM
50 CLOUD PROVIDER

What is claimed is:

1. A network system construction device comprising:
at least one memory storing instructions, and
at least one processor configured to execute the instructions to;
acquire identification information for identifying a network system that is provided from a cloud provider and in which a combination of a plurality of system elements is patterned; and
set configuration information associated with the identification information to the network system identified by the identification information.

2. The network system construction device according to claim 1, wherein the at least one processor is further configured to execute the instructions to pattern a combination of the plurality of system elements.

3. The network system construction device according to claim 2, wherein the at least one processor is further configured to execute the instructions to generate the plurality of system elements of which combination is patterned by using the network system in which a hardware resource is virtualized.

4. The network system construction device according to claim 2, wherein the at least one processor is further configured to execute the instructions to generate a plurality of virtual devices having a common function, and designs the network system by using the plurality of virtual devices.

5. The network system construction device according to claim 2, wherein the at least one processor is further configured to execute the instructions to generate a plurality of virtual devices having a common processing capability, and constructs the network system by using the plurality of virtual devices.

6. The network system construction device according to claim 1, wherein the configuration information includes parameter information for operating the system elements and a program applied to the system elements.

7. The network system construction device according to claim 6, wherein the at least one processor is further configured to execute the instructions to set the parameter information associated with the identification information to the system elements, and then autonomously applies the program to the system elements.

8. The network system construction device according to claim 1, further comprising a database configured to manage the configuration information set to the network system,
wherein the at least one processor is further configured to execute the instructions to collect current setting information of the network system from the network system, compare the configuration information managed in the database with the current setting information of the network system, and set the configuration information associated with the identification information to the network system when the configuration information managed in the database coincides with the current setting information of the network system.

9. The network system construction device according to claim 8, wherein the at least one processor is further configured to execute the instructions to monitor the network system to which the configuration information associated with the identification information is set, and registers a monitoring result in the database.

10-11. (canceled)

12. A network system construction method comprising:
acquiring identification information for identifying a network system that is provided from a cloud provider and in which a combination of a plurality of system elements is patterned; and
setting configuration information associated with the identification information to the network system identified by the identification information.

13. A non-transitory computer-readable medium storing a program causing a computer to execute:
acquiring identification information for identifying a network system that is provided from a cloud provider and in which a combination of a plurality of system elements is patterned; and
setting configuration information associated with the identification information to the network system identified by the identification information.
